(19) United States
(12) Patent Application Publication
(10) Pub. No.: US 2013/0263488 A1
(43) Pub. Date: Oct. 10, 2013

(54) DISPLAY DEVICE AND ASSEMBLY METHOD THEREOF

(71) Applicants: Chia-Hao WU, Hsin-Chu (TW); Han-Ping Kuo, Hsin-Chu (TW); Darman Ng, Hsin-Chu (TW)

(72) Inventors: Chia-Hao WU, Hsin-Chu (TW); Han-Ping Kuo, Hsin-Chu (TW); Darman Ng, Hsin-Chu (TW)

(73) Assignee: AU OPTRONICS CORP., Hsin-Chu (TW)

(21) Appl. No.: 13/571,772

(22) Filed: Aug. 10, 2012

(30) Foreign Application Priority Data
Apr. 6, 2012 (TW) 101112317

(51) Int. Cl. A47G 1/06; B32B 37/14

(52) U.S. Cl. 40/773; 156/305

(57) ABSTRACT

A display device includes a frame, an adhesive tape, a curing adhesive and a display panel. The frame has a top surface, an inner surface and an outer surface. The top surface is connected between the inner surface and the outer surface. The top surface has a first adhesive region and a second adhesive region which are adjacent to each other. The first adhesive region is located between the inner surface and the second adhesive region. The adhesive tape is adhered to the first adhesive region. The display panel is adhered to the top surface of the frame by the adhesive tape. The curing adhesive is adhered to at least one side surface of the display panel, the second adhesive region and the adhesive tape. A display device assembly method is also provided.

### TECHNICAL FIELD

The disclosure relates to a display device and an assembly method thereof, and more particularly to a display device with a slim border and an assembly method thereof.

### BACKGROUND

With the rapid development of the flat panel display technology in recent years, display device is commonly used in various portable electronic products due to having advantages of light weight and thin thickness. Compared with the large and heavy cathode ray tube display device, some present display devices, such as the liquid crystal display (LCD) device and the organic light emitting display device, have a higher image resolution, higher contrast, higher color saturation, and lower power consumption.

However, because requiring a backlight unit for providing light, LCD device must equip with a border for bonding a display panel thereof and the backlight unit; and consequently the LCD device cannot have a slim border design.

FIG. 1 is a schematic partial cross-sectional view of a conventional LCD device. As shown, the conventional LCD device 100 includes a LCD panel 110, a back bezel 120, a frame 130 and a backlight unit 140. Specifically, the LCD panel 110 is disposed on a supporting surface 132 of the frame 130; the backlight unit 140 is disposed under the LCD panel 110; and the back bezel 120 is arranged to enclose the frame 130 and the backlight unit 140. Moreover, the LCD panel 110 is adhered to the supporting surface 132 by an adhesive tape 150; and the frame 130 is adhered to a bottom surface 122 of the back bezel 120 by an adhesive tape 160.

As shown in FIG. 1, the frame 130 has a sidewall 131 and the back bezel 120 has a sidewall 121 both disposed outside the LCD panel 110; wherein the LCD panel 110 and the sidewall 131 are arranged to have a gap 116 therebetween, and the sidewalls 121, 131 are arranged to have a gap 117 therebetween. Thus, the LCD device 100 may have a relatively large border 101 and cannot meet a slim border requirement.

Additionally, as mentioned above in the LCD device 100, the LCD panel 110 is adhered to the supporting surface 132 by the adhesive tape 150. However, if the supporting surface 132 is configured to have a reduced width D1 in response to a slim border requirement and accordingly the area on the supporting surface 132 for the adhesive tape 150 is reduced, the adhesive tape 150 may not provide sufficient adhesion for fixing the LCD panel 110 to the frame 130. And thus, the LCD device 100 may have a poor reliability due to the frame 130 and the LCD panel 110 are easy to be separated from each other.

### SUMMARY OF EMBODIMENTS

Therefore, the present disclosure provides a display device having a slimmer border and a higher reliability.

The present disclosure further provides a display device assembly method applicable to a display device having a slimmer border and a higher reliability.

An embodiment of the disclosure provides a display device, which includes a frame, an adhesive tape, a curing adhesive and a display panel. The frame has a top surface, an inner surface and an outer surface. The top surface is connected between the inner surface and the outer surface. The top surface has a first adhesive region and a second adhesive region which are adjacent to each other. The first adhesive region is located between the inner surface and the second adhesive region. The adhesive tape is adhered to the first adhesive region. The display panel is adhered to the top surface of the frame by the adhesive tape. The curing adhesive is adhered to at least one side surface of the display panel, the second adhesive region and the adhesive tape.

Another embodiment of the disclosure provides a display device assembly method which includes steps of: bonding a display panel to a top surface of a frame through an adhesive tape, wherein a portion of the top surface is exposed from the adhesive tape; and forming a curing adhesive so as to bond at least one side surface of the display panel, the portion of the top surface not covered by the adhesive tape, and the adhesive tape.

In summary, beside through the adhesive tape between the display panel and the top surface of the frame, the display panel can be fixed to the frame more efficiently through the curing adhesive arranged between the side surface of the display panel and the top surface of the frame. And thus, even the adhesive tape has a reduced adhesive area on the top surface of the frame in response to a slim border requirement, the display panel and the frame still can have a sufficient adhesion therebetween through the curing adhesive, and consequently the display panel and the frame can be prevented from being separated from each other. Therefore, the associated display device can have a slimmer border and a higher reliability according to the aforementioned assembly method.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic partial cross-sectional view of a conventional LCD device;

FIG. 2 is a schematic partial cross-sectional view of a display device in accordance with an embodiment of the present disclosure;

FIG. 3 is a schematic three-dimensional view of a display device in accordance with an embodiment of the present disclosure;

FIG. 4 is a schematic top view of the display device shown in FIG. 3;

FIG. 5 is a schematic top view of a display device in accordance with another embodiment of the present disclosure;

FIG. 6 is a schematic top view of a display device in accordance with another embodiment of the present disclosure;

FIG. 7 is a schematic partial cross-sectional view of a display device in accordance with another embodiment of the present disclosure;

FIG. 8 is a schematic partial cross-sectional view of a display device in accordance with another embodiment of the present disclosure;

FIG. 9 is a schematic partial cross-sectional view of a display device in accordance with another embodiment of the present disclosure;

FIG. 10 is a schematic partial cross-sectional view of a display device in accordance with another embodiment of the present disclosure;

FIGS. 11A, 11B, 11C and 11D are schematic cross-sectional views illustrating a display device assembly method in accordance with an embodiment of the present disclosure; and

FIGS. 12A, 12B are schematic cross-sectional views illustrating a portion of a display device assembly method in accordance with another embodiment of the present disclosure.

### DETAILED DESCRIPTION OF EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

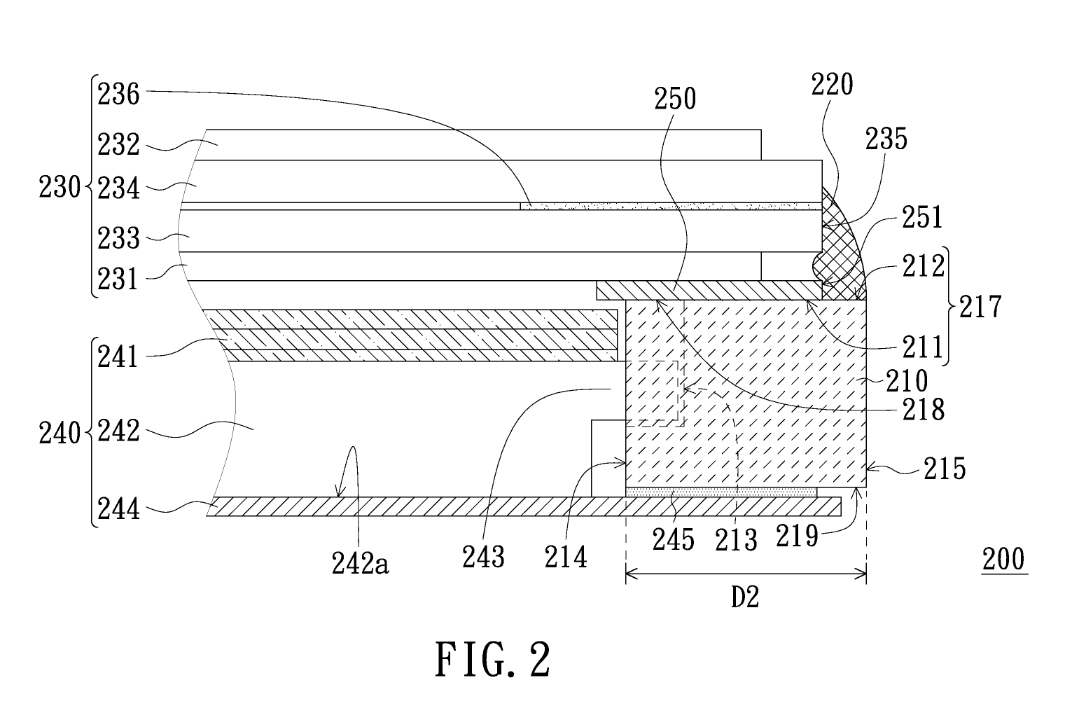

FIG.2 is a schematic partial cross-sectional view of a display device in accordance with an embodiment of the present disclosure. As shown, the display device 200 in this embodiment includes a frame 210, a curing adhesive 220, a display panel 230 and an adhesive tape 250. The frame 210 has a top surface 217, an inner surface 214 and an outer surface 215; wherein the top surface 217 is connected between the inner surface 214 and the outer surface 215. The top surface 217 has a first adhesive region 211 and a second adhesive region 212; wherein which the first adhesive region 211 and the second adhesive region 212 are adjacent to each other, and the first adhesive region 211 is defined between the inner surface 214 and the second adhesive region 212. The adhesive tape 250 is adhered to the first adhesive region 211; and the display panel 230 is boned to the first adhesive region 211 through the adhesive tape 250. The curing adhesive 220 is adhered to a side surface 235 of the display panel 230, the second adhesive region 212 and the adhesive tape 250; specifically, in this embodiment the curing adhesive 220 is, for example, adhered to a side surface 251 of the adhesive tape 250. In addition, the first adhesive region 211 herein is referred to as a region on the top surface 217 for the adhesive tape 250; the second adhesive region 212 herein is referred to as a region on the top surface 217 for the curing adhesive 220; and the first adhesive region 211 and the second adhesive region 212 both can have no viscidity.

The adhesive tape 250 is a light-blocking adhesive tape, and the disclosure is not limited thereto. The curing adhesive 220 is an optical curing adhesive (for example, an ultraviolet curing adhesive) or a thermal curing adhesive, and the disclosure is not limited thereto. In this embodiment, the display panel 230 includes, for example, a first polarizer 231, a second polarizer 232, a first substrate 233 and a second substrate 234. Specifically, the display panel 230 is adhered to the adhesive tape 250 via an edge area of the first polarizer 231; the first substrate 233 is disposed on the first polarizer 231; the second substrate 234 is disposed on the first substrate 233; and the second polarizer 232 is disposed on the second substrate 234. In this embodiment, the display panel 230 is, for example, a liquid crystal display (LCD) panel; and the first substrate 233 and the second substrate 234 are arranged to have a liquid crystal layer (not shown) therebetween. In this embodiment, the curing adhesive 220 is adhered to a side surface of the first substrate 233 and a side surface of the second substrate 234 both; however, it is understood that the curing adhesive 220 can be adhered to a side surface of the first substrate 233 only in another embodiment. In addition, a light-blocking layer 236, configured to avoid light leakage, is formed in an area surrounding outside a display region of the display panel 230 and between the first substrate 233 and the second substrate 234. It is understood that the aforementioned structure of the display panel 230 is for an example purposes only; in other words, the present disclosure is not limited by the type of the display panel.

It is to be noted that the display device 200 further includes a backlight unit 240, configured to provide light to the display panel 230, if the display panel 230 is a non-self-luminescent display panel. The backlight unit 240 includes, for example, a light guide plate 242 and a light emitting element (not shown). The light guide plate 242 is disposed in a region surrounded by the inner surface 214 of the frame 210. The light emitting device is configured to emit light beams into the light guide plate 242; and the light guide plate 242 is configured to convert the light beams into surface light for the display panel 230. In addition, the backlight unit 240 may further include at least one optical film 241, which is disposed on the light guide plate 242 and between the light guide plate 242 and the display panel 230. It is to be noted that the backlight unit 240 in this embodiment is exemplified by including more than one optical film 241; wherein these optical films 241 can be a diffuser, a brightness enhancement film or other types of film material capable of increasing the brightness or homogenizing the display light. In addition, a portion of the adhesive tape 250 are arranged to overlap an edge area of the optical film 241. In the embodiment of the adhesive tape 250 being a light-blocking adhesive, the portion of the adhesive tape 250 overlapping the edge area of the optical films 241 can prevent the optical film 241 from having over-high brightness in the edge area thereof; wherein the over-high brightness may affect the display quality of the display device 200. In addition, the backlight unit 240 may further include a reflector 244, which is disposed under the light guide plate 242 and configured to prevent the light in the light guide plate 242 from being emitted out from a bottom surface 242a of the light guide plate 242, so as to avoid light loss. The edge area of the reflector 244 is, for example, bonded to a bottom surface 219 of the frame 210 through an adhesive tape 245.

As illustrated in the display device 200 of this embodiment, the display panel 230 and the frame 210 can have, besides the adhesion provided by the adhesive tape 250 arranged between the display panel 230 and the top surface 217 of the frame 210, an enhanced adhesion therebetween provided by the curing adhesive 220 arranged between the side surface 235 of the display panel 230 and the top surface 217 of the frame 210. And thus, the display panel 230 and the frame 210 can be prevented from being separated from each other more efficiently; and accordingly the display panel 230 and the frame 210 can be fixed to each even the frame 210 is configured to have a reduced width D2 in response to a slim border requirement. Therefore, the display device 200 in this embodiment can have a slimmer border and a higher reliability based on the aforementioned structure.

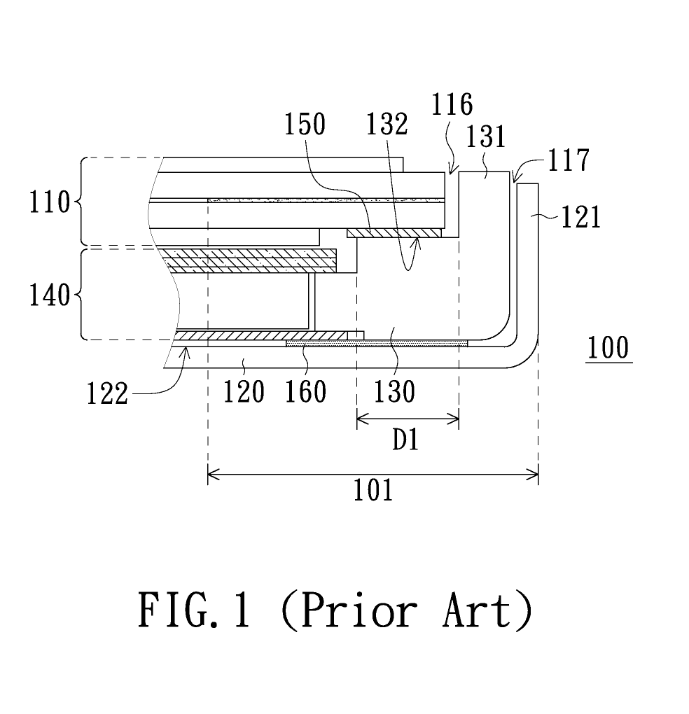

It is to be noted that the border width of the display device 200 in this embodiment can be further reduced due to a back bezel (such as the back bezel 120 as illustrated in FIG. 1 in related art) can be omitted therein. Moreover, unlike being supported by the back bezel 120 in related art, in this embodiment the light guide plate 242 is supported is by the frame 210. Specifically, the light guide plate 242 is configured to have at least one protuberant part 243 (the light guide plate 242 herein is exemplified by having one protuberant part 243 only as illustrated in FIG. 2) on a side surface thereof, and correspondingly the frame 210 is configured to have at least one accommodation groove 213 (the frame 210 herein is exemplified by having one accommodation groove 213 only as illustrated in FIG. 2) on the inner surface 214 thereof; wherein the accommodation groove 213 is configured for the accommodation of the corresponding protuberant part 243, and the number of the accommodation groove 213 is corresponding to that of the protuberant part 243. Through the aforementioned structure, the light guide plate 242 can be fixed to the frame 210 via a combination of the protuberant part 243 and the accommodation groove 213. In this embodiment, the accommodation groove 213 is, for example, exposed from the top surface 217 of the frame 210. In other words, the accommodation groove 213 is configured to have an opening 218 on the top surface 217 of the frame 210; and thus, the protuberant part 243 of the light guide plate 240 can be arranged into the accommodation groove 213 through the opening 218 more easily. In addition, similar to the protuberant part 243 of the light guide plate 242, the optical film 241 can also have at least one protuberant part (not shown), which is accommodated in the corresponding accommodation groove 213 and configured to limit the movement of the optical film 241, but the disclosure is not limited thereto. It is understood that the protuberant part of the optical film 241 and the protuberant part 243 of the light guide plate 242 are not necessary to be accommodated in a same accommodation groove. In another embodiment, the top surface 217 of the frame 210 may not expose the accommodation groove; in other words, the accommodation groove has one opening on the inner surface 214 of the frame 210 only.

Following is the in-detailed description about the coating position of the curing adhesive 220, and it is to be noted that the following description is for purpose of illustration and description only.

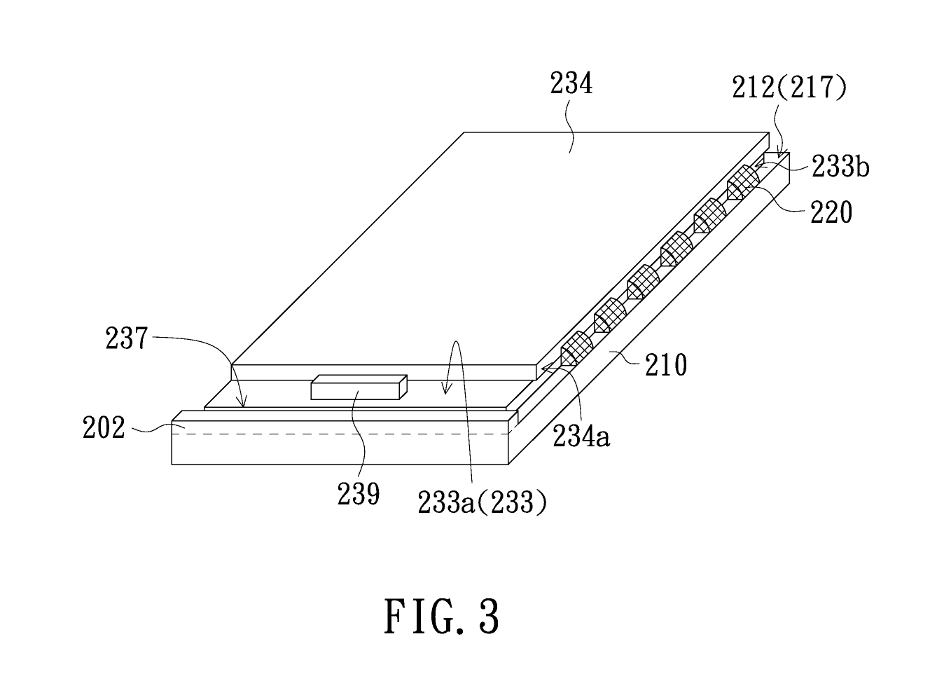

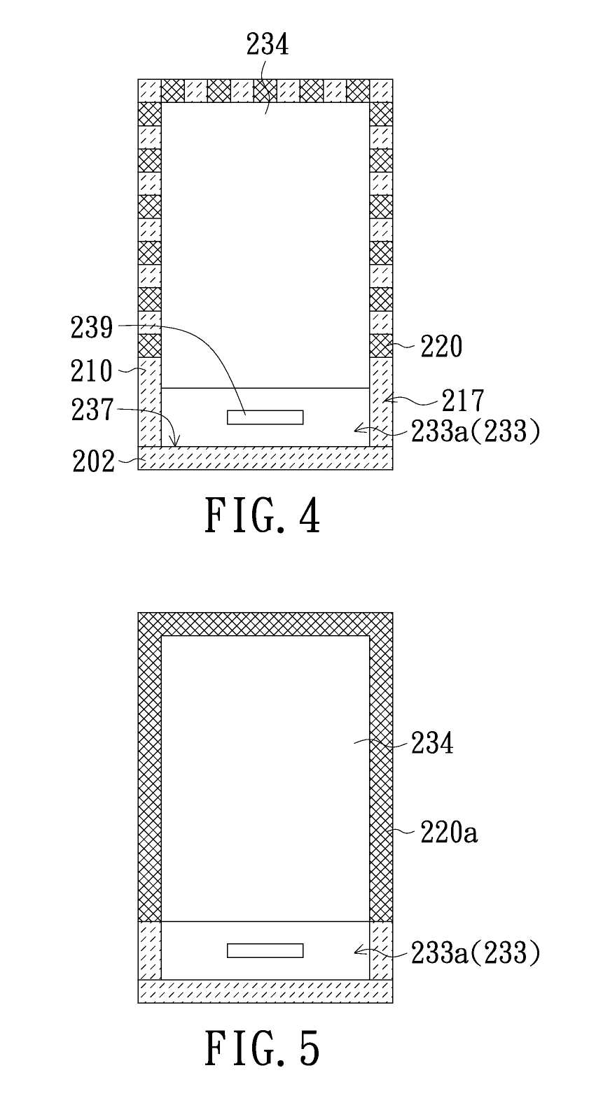

FIG. 3 is a schematic three-dimensional view of a display device in accordance with an embodiment of the present disclosure; and FIG. 4 is a schematic top view of the display device shown in FIG. 3. Please refer to FIGS. 3, 4 both. The first substrate 233 has a wireline region 233a, which is defined as a region on the first substrate 233 not covered by the second substrate 234 and is configured to be disposed with a driving chip 239 and associated wire lines (not shown). The frame 210 further includes a supporting part 202 disposed on the top surface 217 thereof. Specifically, the supporting part 202 is arranged to be opposite to the side surface 237 which is an edge of the wireline region 233a far away the second substrate 234; and the side surface 237 is, for example, supported on the supporting part 202. Because having the driving chip 239 and the associated wire lines thereon and also for the following packages and tests, generally the wireline region 233a is not coated with the curing adhesive 220, but the disclosure is not limited thereto. Furthermore, the first substrate 233 has a plurality of side surfaces 233b and the second substrate 234 has a corresponding number of side surfaces 234a, and the side surfaces 233b each is bounded to a corresponding side surface 234a by the curing adhesive 220. In this embodiment, the curing adhesive 220 is coated to have a plurality of dotted patterns.

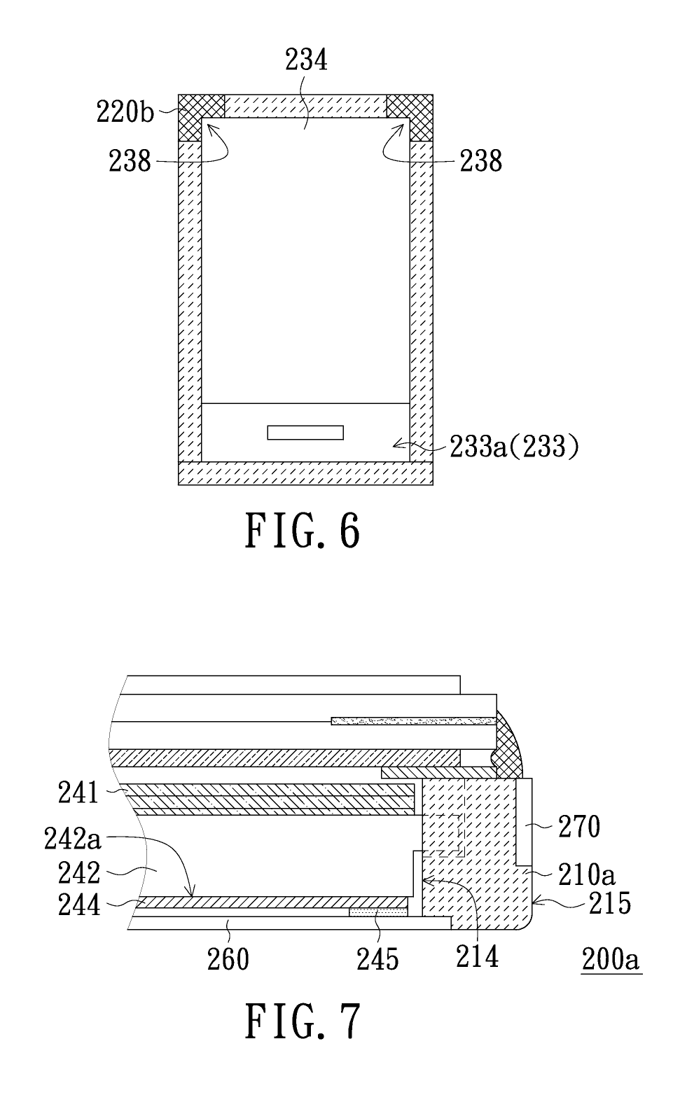

In another embodiment as illustrated in FIG. 5, the curing adhesive 220a is coated to have a plurality of stripped patterns. In still another embodiment as illustrated in FIG. 6, the curing adhesive 220b is adhered to at least one corner 238, which is referred to as a pair of corresponding corners of the first substrate 233 and the second substrate 234 respectively. It is understood that the curing adhesive in the present disclosure can have a combination of the dotted patterns, the stripped patterns or other forms of patterns; and the disclosure is not limited thereto.

FIG. 7 is a schematic partial cross-sectional view of a display device in accordance with another embodiment of the present disclosure. As shown, the display device 200a in this embodiment has a structure similar to that of the aforementioned display device 200; and the main difference between the two embodiments is that the display device 200a further includes a supporting component 260, which is arranged to face to the bottom side 242a of the light guide plate 242 and capable of being inserted into an inner surface 214 of a frame 210a so as to support the light guide plate 242, the reflector 244, the optical film 241 and other components of the associated backlight unit. The reflector 244 is, for example, bonded to the supporting component 260 through the adhesive tape 245. The supporting component 260 and the frame 210a have different materials; for example, the supporting component 260 contains metal materials and the frame 210a contains plastic materials, and the disclosure is not limited thereto. In addition, the display device 200a may further include a structural-reinforcement component 270, which is embedded into an outer surface 215 of the frame 210a and configured to reinforce the structural strength of the frame 210a so as to prevent the frame 210a from a deformation. The structural-reinforcement component 270 and the frame 210a have different materials; for example, the structural-reinforcement component 270 contains metal materials and the frame 210a contains plastic materials, and the disclosure is not limited thereto.

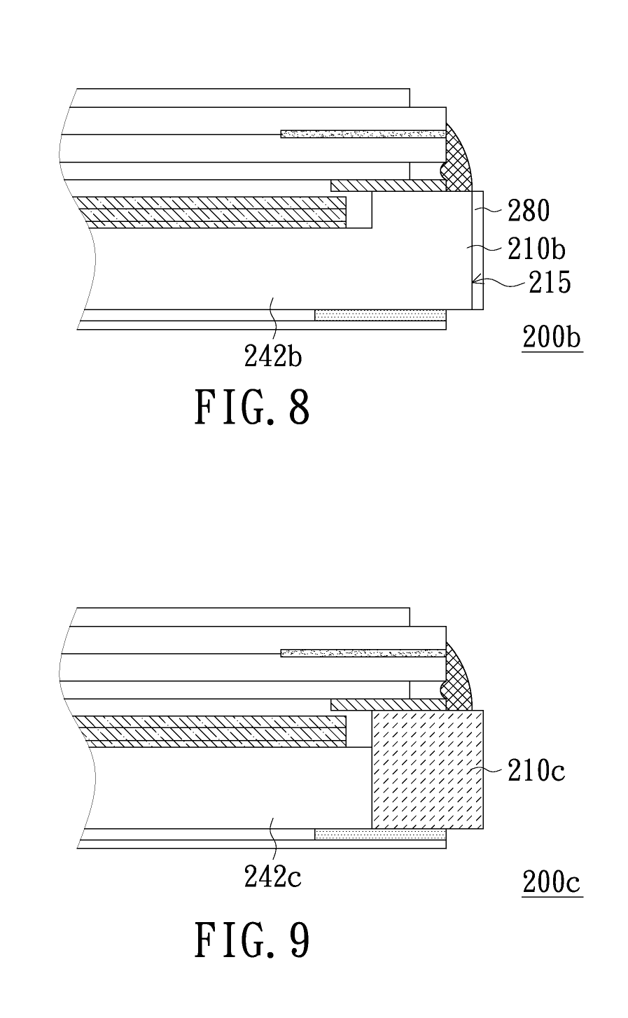

FIG. 8 is a schematic partial cross-sectional view of a display device in accordance with another embodiment of the present disclosure.

As shown, the display device 200b in this embodiment has a structure similar to that of the aforementioned display device 200; and the main difference between the two embodiments is that the light guide plate 242b and the frame 210b in the display device 200b are corporately configured to have a one-piece structure, wherein the light guide plate 242b and the frame 210b have same materials. Thus, the frame 210b does not need an accommodation groove(s) and the light guide plate 242b does not need a corresponding protuberant part(s) for the fixing to each other, and consequently the light guide plate 242b and the frame 210b each can have a simpler structure. Moreover, the display device 200b can have higher assembly efficiency due to no need of assembling the light guide plate 242b and the frame 210b to each other. Furthermore, a reflector 280 is, due to the light guide plate 242b and the frame 210b have same materials, disposed on an outer surface 215 of the frame 210b and configured to reflect light back to the light guide plate 242b. Thus, light loss, caused by the leakage light emitted out from the outer surface 215 of the frame 210b, is avoided and consequently the display device 200b can have a higher light usage efficiency.

FIG. 9 is a schematic partial cross-sectional view of a display device in accordance with another embodiment of the present disclosure. As shown, the display device 200c in this embodiment has a structure similar to that of the aforementioned display device 200; and the main difference between the two embodiments is that the light guide plate 242c and the frame 210c in the display device 200c are corporately configured to have a one-piece structure, wherein the light guide plate 242c and the frame 210c have different materials and the light guide plate 242c and the frame 210c are, for example, manufactured by a double injection molding mean. Thus, the frame 210c does not need an accommodation groove(s) and the light guide plate 242c does not need a corresponding protuberant part(s) for the fixing to each other, and consequently the light guide plate 242c and the frame 210c each can have a simpler structure. Moreover, the display device 200c can have higher assembly efficiency due to no need of assembling the light guide plate 242c and the frame 210c to each other. Furthermore, the frame 210c can be made by material having a higher optical reflectivity so as to avoid light loss caused by the leakage light emitted from the frame 210c.

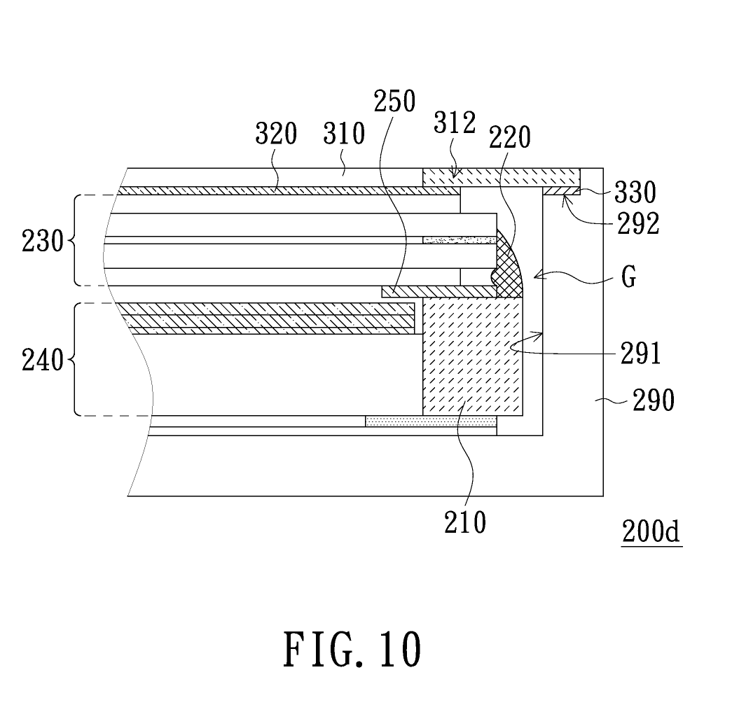

FIG. 10 is a schematic partial cross-sectional view of a display device in accordance with another embodiment of the present disclosure. As shown, the display device 200d in this embodiment has a structure similar to that of the aforementioned display device 200; and the main difference between the two embodiments is that the display device 200d further includes an outer frame 290 configured to enclose the frame 210, the display panel 230, the adhesive tape 250 and the curing adhesive 220. The outer frame 290 has an inner surface 291 and a supporting surface 292; wherein the inner surface 291 is connected to the supporting surface 292 and arranged to face to the frame 210. A portion (close to the curing adhesive 220) of the inner surface 291 and the curing adhesive 220 are arranged to have a gap G therebetween. In this embodiment, the outer frame 290 can function as an appearance component of an associated electronic product (for example, a television, computer monitor, notebook computer, tablet PC, mobile phone or other portable electronic product) which adopts the display device 200d. In this embodiment, because there is no need to arrange a back bezel (such as the back bezel 120 as illustrated in FIG. 1 in related art) between the outer frame 290 and the frame 210, the associated electronic product can have a slimmer border so as to response to the slim border design requirement.

In addition, the display device 200d may further include a protection plate 310, which is fixed on the supporting surface 292 of the outer frame 290 and configured to cover and protect the display panel 230. The protection plate 310 can be a glass, acrylic sheet, or other types of transparent plate. In addition, the protection plate 310 and the display panel 230 can be arranged to have an optical clear adhesive 320 therebetween, which is for the bonding of the protection plate 310 and the display panel 230. In addition, an edge area of the protection plate 310 is defined as a light-blocking region 312, which is fixed to the outer frame 290 and configured to cover the edge area of the display panel 230 and the curing adhesive 220. In this embodiment, the protection plate 310 can be bonded to the supporting surface 292 of the outer frame 290 through an adhesive layer 330.

It is to be noted that the display device 200d does not have to use the adhesive layer 330 and the optical clear adhesive 320 both at a same time; in other words, the display device 200d can use either the adhesive layer 330 or the optical clear adhesive 320 based on an actual requirement. In addition, it is to be noted that the protection plate 310 can be bonded to the supporting surface 292 of the outer frame 290 by other means without the adhesive layer 330 and the optical clear adhesive 320.

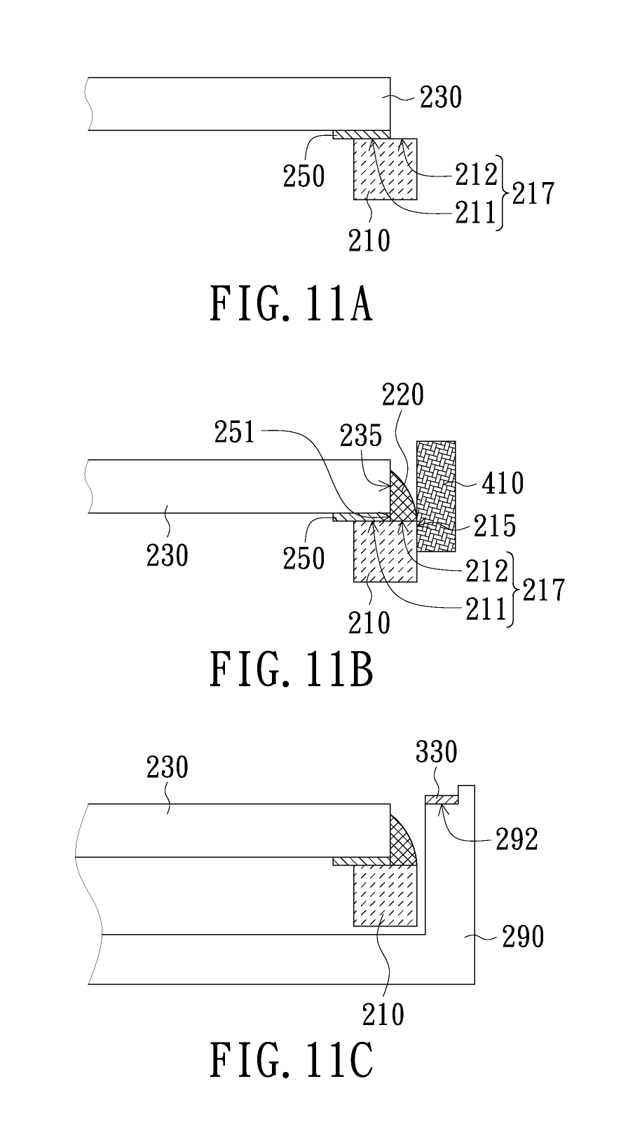

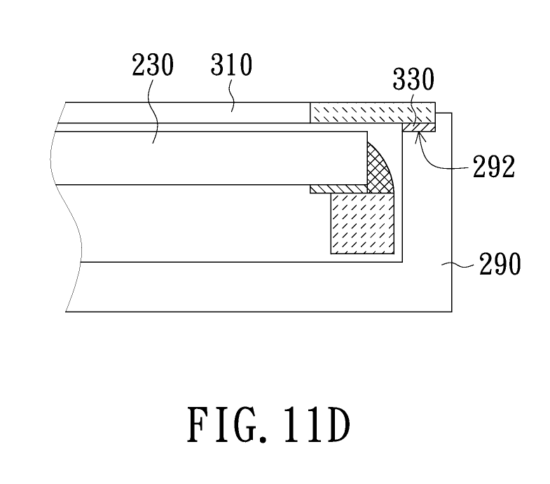

FIGS. 11A, 11B, 11C and 11D are schematic cross-sectional views illustrating a display device assembly method in accordance with an embodiment of the present disclosure. The assembly method in this embodiment is applicable to the display device in each above-mentioned embodiment; and it is to be noted that, for the convenience to describe the assembly method, some components (for example, the light guide plate) are omitted from the FIGS. 11A, 11B, 11C and 11D. The assembly method in this embodiment includes the following steps: firstly, as illustrated in FIG. 11A, the display panel 230 is bonded to the top surface 217 of the frame 210 through the adhesive tape 250; wherein a portion of the top surface 217 is exposed from the adhesive tape 250. Herein, the portion of the top surface 217 covered by the adhesive tape 250 is referred to as the first adhesive region 211; and the portion of the top surface 217 not covered by the adhesive tape 250 is referred to as the second adhesive region 212.

Then, as illustrated in FIG. 11B, the curing adhesive 220 is formed and thereby being adhered to the side surface 235 of the display panel 230, the top surface 217 of the frame 210 not covered by the adhesive tape 250 (that is, the second adhesive region 212) and the adhesive tape 250 (for example, the side surface 251 of the adhesive tape 250). In this embodiment, the formation of the curing adhesive 220 includes steps of: coating a colloid and solidifying the colloid so as to form the curing adhesive 220. It is to be noted that the coating and the solidifying of the colloid can be performed simultaneously; or, the solidifying of the colloid can be performed after the completeness of the coating of the colloid. In addition, a spill-proof component 410 is, before the coating of the colloid, disposed to be supported on the outer surface 215 of the frame 210 so as to avoid an overflow of the colloid; wherein the outer surface 215 is connected to the top surface 217. Then, the spill-proof component 410 is removed after the colloid is solidified into the curing adhesive 220. It is to be noted that the spill-proof component 410 is not required if a specific colloid, capable of not overflowing the outer surface 215 of the frame 210, is selected.

The display device assembly method according to this embodiment may further include a step of enclosing the adhered display panel 230 and the frame 210 by an outer frame and a protection plate. Specifically, as illustrated in FIG. 11C, the adhered display panel 230 and the frame 210 are arranged in the outer frame 290; wherein the outer frame 290 is disposed with an adhesive layer 330 on a supporting surface 292 thereof.

Then, as illustrated in FIG. 11D, a protection plate 310 is fixed to the supporting surface 292 of the outer frame 290 through the adhesive layer 330 so as to cover the display panel 230 by the protection plate 310. The protection plate 310 and the display panel 230 may be arranged to have a gap therebetween; alternatively, the protection plate 310 may be directly contacted to the display panel 230.

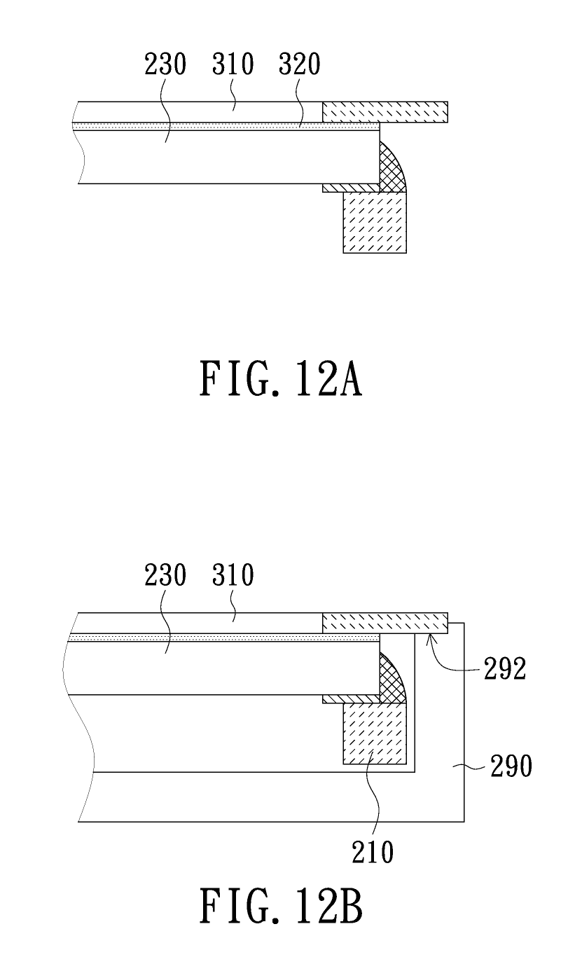

FIGS. 12A, 12B are schematic cross-sectional views illustrating a portion of a display device assembly method in accordance with another embodiment of the present disclosure. As illustrated in FIG. 12A, the protection plate 310 is, once the step of FIG. 11B is complete, bonded to the display panel 230 through the optical clear adhesive 320. Then, as illustrated in FIG. 12B, the adhered display panel 230 and the frame 210 are arranged in the outer frame 290, and then the protection plate 310 is supported on the supporting surface 292 of the outer frame 290. In addition, the protection plate 310 and the outer frame 290 can be fixed to each other by coating an adhesive layer (not shown) therebetween or by other means without the adhesive layer.

According to the aforementioned display device assembly methods, beside through the adhesive tape 250 between the display panel 230 and the top surface 217 of the frame 210, the display panel 230 can be fixed to the frame 210 more efficiently through the curing adhesive 220 between the side surface 235 of the display panel 230 and the top surface 217 of the frame 210. And thus, even the adhesive tape 250 has a reduced adhesive area on the top surface 217 of the frame 210 in response to a slim border requirement, the display panel 230 and the frame 210 still can have a sufficient adhesion therebetween through the curing adhesive 220, and consequently the display panel 230 and the frame 210 can be prevented from being separated from each other. Therefore, the associated display device can have a slimmer border and a higher reliability according to the aforementioned assembly method.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A display device, comprising:
a frame having a top surface, an inner surface and an outer surface, wherein the top surface is connected between the inner surface and the outer surface, the top surface has a first adhesive region and a second adhesive region which are adjacent to each other, the first adhesive region is located between the inner surface and the second adhesive region;
an adhesive tape adhered to the first adhesive region;
a display panel adhered to the top surface of the frame by the adhesive tape; and
a curing adhesive adhered to at least one side surface of the display panel, the second adhesive region and the adhesive tape.

2. The display device according to claim 1, wherein the curing adhesive has a plurality of dotted patterns or at least one stripped pattern.

3. The display device according to claim 1, wherein the display panel comprises a first substrate, a second substrate, a first polarizer and a second polarizer, the first polarizer is adhered to the adhesive tape, the first substrate is disposed on the first polarizer, the second substrate is disposed on the first substrate, and the second polarizer is disposed on the second substrate.

4. The display device according to claim 3, wherein the first substrate has a wireline region which is not covered by the second substrate, the first substrate has a plurality of side surfaces and the second substrate has a plurality of corresponding side surfaces, the side surfaces of the first substrate are respectively bonded to the side surfaces of the second substrate by the curing adhesive.

5. The display device according to claim 3, wherein the first substrate has a wireline region which is not covered by the second substrate, at least one corner of the first substrate is corresponding to at least one corner of the second substrate, the curing adhesive is adhered to the corresponding corners of the first substrate and the second substrate.

6. The display device according to claim 3, wherein the first substrate has a wireline region which is not covered by the second substrate, the frame further includes a supporting part disposed on the top surface, the supporting part is arranged to be facing to one side surface of the wireline region far away the second substrate.

7. The display device according to claim 1, further comprising a light guide plate disposed in a region surrounded by the inner surface of the frame, at least one side surface of the light guide plate has at least one protuberant part, the inner surface of the frame has at least one accommodation groove for an accommodation of the at least one protuberant part.

8. The display device according to claim 7, wherein the accommodation groove is exposed from the top surface of the frame.

9. The display device according to claim 7, further comprising a supporting component inserted into the inner surface of the frame, wherein the supporting component is disposed on a bottom surface of the light guide plate and configured to support the light guide plate, the supporting component and the frame have different materials.

10. The display device according to claim 7, further comprising a structural-reinforcement component inserted into the outer surface of the frame, wherein the structural-reinforcement component and the frame have different materials.

11. The display device according to claim 1, further comprising a light guide plate disposed in a region surrounded by the inner surface of the frame and connected to the inner surface, wherein the light guide plate and the frame are corporately configured to have a one-piece structure, the light guide plate and the frame have same materials.

12. The display device according to claim 11, further comprising a reflector disposed on the outer surface of the frame.

13. The display device according to claim 1, further comprising a light guide plate disposed in a region surrounded by the inner surface of the frame and connected to the inner surface, wherein the light guide plate and the frame are corporately configured to have a one-piece structure, the light guide plate and the frame have different materials.

14. The display device according to claim 1, further comprising a light guide plate and at least one optical film, wherein the light guide plate is disposed in a region surrounded by the inner surface of the frame, the optical film is disposed on the light guide plate, and a portion of the adhesive tape and an edge area of the optical film are arranged to stack to each other.

15. The display device according to claim 1, further comprising an outer frame configured to enclose the frame, the display panel, the adhesive tape and the curing adhesive, wherein the outer frame has an inner surface and a supporting surface, the inner surface is connected to the outer surface and arranged to face to the frame, the curing adhesive and a portion of the inner surface close to the curing adhesive are arranged to have a distance therebetween.

16. The display device according to claim 15, further comprising a protection plate fixed on the supporting surface of the outer frame and configured to cover the display panel.

17. The display device according to claim 16, further comprising an optical clear adhesive disposed between the protection plate and the display panel.

18. The display device according to claim 16, wherein an edge area of the protection plate is a light-blocking region, the light-blocking region is fixed to the outer frame and configured to cover an edge area of the display panel and the curing adhesive.

19. A display device assembly method, comprising:
bonding a display panel to a top surface of a frame through an adhesive tape, wherein a portion of the top surface is exposed from the adhesive tape; and
forming a curing adhesive so as to bond at least one side surface of the display panel, the portion of the top surface not covered by the adhesive tape, and the adhesive tape.

20. The display device assembly method according to claim 19, wherein the step of forming the curing adhesive comprises:
coating a colloid; and
solidifying the colloid.

21. The display device assembly method according to claim 20, wherein the step of forming the curing adhesive further comprises:
supporting a spill-proof component on an outer surface of the frame before the coating of the colloid; wherein the outer surface is connected to the top surface.

22. The display device assembly method according to claim 19, further comprising:
disposing the adhered display panel and the frame in an outer frame, wherein an adhesive layer is disposed on a supporting surface of the outer frame; and
fixing a protection plate on the supporting surface through the adhesive layer so as to cover the display panel with the protection plate.

23. The display device assembly method according to claim 19, further comprising:
bonding a protection plate on the display panel through an optical clear adhesive to cover the display panel; and
disposing the adhered display panel and the frame in an outer frame and supporting the protection plate on a supporting surface of the outer frame.
